(19) United States
(12) Patent Application Publication
(10) Pub. No.: US 2021/0325904 A1
(43) Pub. Date: Oct. 21, 2021

(54) GUIDANCE SYSTEM FOR GUIDING AN AIRCRAFT ALONG AT LEAST ONE SECTION OF AN AIR ROUTE

(71) Applicants: UNIVERSITE DE BORDEAUX, Bordeaux (FR); INSTITUT POLYTECHNIQUE DE BORDEUX, Talence (FR); CENTRE NATIONAL DE LA RECHERCHE SCIENTIFIQUE - CNRS, Paris (FR)

(72) Inventor: Serge CHAUMETTE, Talence (FR)

(21) Appl. No.: 16/319,663

(22) PCT Filed: Jul. 20, 2017
(86) PCT No.: PCT/FR2017/052003

§ 371 Date: Jan. 22, 2019

(30) Foreign Application Priority Data
Jul. 20, 2016 (FR) 16/56925

(51) Int. Cl. G05D 1/10; B64C 39/02

(52) U.S. Cl. CPC G05D 1/104; B64C 39/022; B64C 2201/146; B64C 2201/066; B64C 2201/127; B64C 39/024

(57) ABSTRACT

Disclosed is a guidance system for guiding an aircraft along at least one section of an air route, which includes at least one air guidance line defining at least one section of an air route, and a unit for following the at least one guidance line, the unit being carried on the aircraft and being configured to keep the aircraft aligned or substantially aligned with the at least one air guidance line. The following unit includes an arm designed to connect the aircraft to the at least one guidance line.

### BACKGROUND OF THE INVENTION

### Field of the Invention

The present invention relates to a guidance system for guiding an aircraft, in particular an unmanned aircraft, along at least one section of an air route.

### Technological Background

Drones are undergoing a very significant commercial expansion because of the technological advances made in recent years, which make these flying machines increasingly more sophisticated, lightweight and of leisure use. They now find applications not only in the military and professional fields but also with the public at large.

Thus, drones are known that are remotely piloted by means of a remote control device or a mobile tablet on which suitable software is running, the pilot on the ground receiving the images taken by an embedded camera, in real time, for the piloting of the drone.

The control signals necessary to the piloting of this drone are typically sent by radio frequency (RF) link.

However, it is important to ensure that the drone remains placed within the range of the antenna of the transmitter in order to not lose contact with the drone in flight. The action radius of such a drone is, consequently, limited.

Furthermore, the presence of obstacles such as buildings or trees, or level differences such as hills, can interrupt the radio link and, consequently, result in a break in the drone control link.

Also known are drones equipped with an automatic piloting system allowing them, outdoors, to follow a predefined path and return, if necessary, to their initial GPS position.

Now, it is found that the receivers of GPS satellite signals allowing these drones to determine their position exhibit greater or lesser reliability. The drone can thus land a few meters away from its departure point or drift in steady-state flight, which requires the pilot to pay particular attention.

Furthermore, when such a drone flies in a closed environment, inside a building, for example to carry out the inspection of an industrial installation, the piloting of this drone proves much more complex.

First of all, the line of sight of the satellites necessary to the reception of a signal is at least partially masked such that the GPS signals are greatly attenuated, even nil.

Incapable of accurately determining their 3D location coordinates, the drones cannot hold their position and soon strike the first obstacle to appear, for example a wall.

Obviously, the impossibility of determining the position of a drone is incompatible with fully unmanned flight.

Furthermore, interference associated with the presence of electrical appliances in the building can disrupt the reception or the transmission of the RF signals necessary to the piloting of the drone.

Moreover, some drones are equipped for indoor flight with an embedded camera, which is oriented downward for the acquisition of marker points on the ground. However, obstacles present outside of the field of the camera can damage the drone, even cause it to fall when one or more of its propellers are touched.

Now, the falling of a drone can not only result in irreversible damage to the latter, but can also injure one or more people who are at the point of impact on the ground. As an example, the blades of a rotary wing drone constitute high speed cutting elements.

There is therefore a pressing need for a system for guiding a drone indoors or outdoors, the original design of which remedies the drawbacks of the prior art summarized above.

### OBJECT OF THE INVENTION

The present invention relates to a system for guiding an aircraft, such as an unmanned aircraft, along at least one section of an air route, that is simple in its design and in its mode of operation, that is economical and reliable, to facilitate the navigation of this aircraft.

Also an object of the present invention is such a system allowing the drone to locate its position with the desired measurement accuracy, particularly in a closed environment where the reception of GPS signals is impossible or in an open environment with obstacles likely to result in a break in the radio link.

Another object of the present invention is such a system which makes it possible to increase the safety of the aircraft and, if necessary, of the people or objects present on the ground within the flight zone of the aircraft.

Yet another object of the present invention is such a system allowing the creation and the organization of air routes for unmanned aircraft in a particularly easy and rapid manner.

The present invention also targets a method for managing at least two unmanned aircraft, for example a fleet of drones, making it possible to simply and effectively prevent collisions between these aircraft when they are moving around in one and the same zone of space.

### BRIEF DESCRIPTION OF THE INVENTION

To this end, the invention relates to a guidance system for guiding an aircraft along at least one section of an air route.

According to the invention, this system comprises:
at least one air guidance line defining at least one section of an air route,
a means for following said at least one guidance line, borne by said aircraft, said following means being configured to keep said aircraft aligned, or substantially aligned, on said at least one air guidance line, and
said following means comprises an arm configured to link the aircraft to said at least one air guidance line.

The present invention is particularly suited to the guiding of an air drone, that is to say an unmanned aircraft or an aircraft without a human pilot onboard.

Such a guidance system can be implemented to guide an aircraft over all of a trajectory followed by this aircraft or over a section or several sections of this trajectory.

Thus, and purely illustratively, in a flight outdoors, such a system advantageously makes it possible, when there are obstacles likely to result in a break in the radio link, to generate a trajectory in complete autonomy for the drone that makes it possible to pass these obstacles. The triggering of the return to the initial position, or return to home (RTH) function of the drone is thus avoided.

In indoor flight, the motor or motors of this aircraft can be locked in position in order for the aircraft to follow a trajectory which will have been determined by one or more air guidance lines and possibly one or more light beams.

Such position-locking also allows an aircraft to move around within a narrow space such as a duct or a tunnel, without risk of the aircraft striking the wall or walls delimiting these elements.

The inspection of narrow zones or where there are obstacles is thus made possible. When a zone of space comprises at least two air routes, the air guidance line or lines and possibly the light beam or beams determining these air routes are not necessarily parallel, but can, on the contrary, intersect, even be at right angles. Obviously, the present invention is not limited to an air route of particular form.

Purely illustratively, this arm can be a rigid element such as a strut or a flexible element such as a cable.

More generally, the following means of said guidance system comprises an arm configured to link the aircraft to said or to at least one of said air guidance lines. Obviously, this following means can comprise one or more such arms.

Advantageously, such an arm makes it possible to link the aircraft to the air guidance line along which it moves to assist its navigation along this line, the aircraft moving at a distance d from the line defined by the length of the arm when the arm is rigid. This link can also ensure an attachment of the aircraft to said line to avoid a fall and loss of the aircraft in case of the occurrence of incident such as a breakdown. As an example, the free end of the arm can comprise a device for rapidly securing to or separating from said air guidance line.

Various particular embodiments of this guidance system can be conceived, each having its particular advantages and being open to many possible technical combinations:
this arm is a telescopic arm.

Advantageously, such an embodiment allows an adjustment of the distance separating the aircraft from the air guidance line. In a landing phase, this arm can thus be collapsed to a retracted position.

Preferably, the deployment and the retraction of the arm are motorized, these actions being, for example, remotely controllable.
each air guidance line is chosen from the group comprising a cable, a wire, a cord, a solid or hollow bar, and combinations of these elements.

This or these air guidance lines are therefore formed by solid elements.
this following means comprises at least one mechanical contact-based or induction-based or even ultrasound-based device for detecting said at least one guidance line for following the line.

Such a detection device then makes it possible to determine the relative position of the aircraft in relation to the corresponding air guidance line.

In a particular embodiment, at least one mechanical contact-based detection device comprises a link member chosen from the group comprising an open or closed ring, an openable ring, a tubular portion that is longitudinally open or not, an openable tubular portion and combinations of these elements.

Purely illustratively, this openable ring can be a non-closed annular piece defining an opening, a clasp being mobile between a position of opening, in which, being placed at a distance from the opening, it leaves this annular piece open, and a position of closing, in which it blocks the opening of the annular piece. A remotely-controllable actuator makes it possible to move the clasp between these positions of opening and of closing.

When the link member is closed, it surrounds, preferably, the air guidance line. There is thus, advantageously, an assurance of the recovery of the aircraft in case of breakdown it, for example following a falling, this aircraft then remaining linked to the air guidance line.

Also avoided, when the air guidance line is placed at a certain height relative to the ground, is having a person who is in the zone of flight of the aircraft being accidentally injured by the falling of the aircraft.

Preferentially, this link member can be placed at the free end of an arm such as a rod, possibly of adjustable length, for example a telescopic arm, making it possible to set the distance, or separation, between the aircraft and the air guidance line.

This arm can be composed of a flexible link, such as a cable, of a winding/unwinding device.

Advantageously, the implementation of such an air guidance line allows the take-off or free flight of an aircraft, that is to say not guided by a guidance system of the invention, to come to be positioned, either in automatic piloting mode or by being remotely-controlled, around such an air guidance line. The mechanical detection device thus ensures reliable and rapid detection of the air guidance line for the placement of the aircraft on the section of air route defined by the line. Movement of an aircraft from a first site to another, not linked to one another, is thus greatly simplified. For example, the aircraft can take off from a segregated zone in free flight, then fly over a zone containing members of the public by being guided by an air guidance line and by being attached thereto by a closed mechanical detection device. Advantageously, current regulations are observed.

Furthermore, such an aircraft can rejoin and be placed around an air guidance line situated in a zone that is difficult to access without the operator him or herself having to intervene. This air guidance line can even have been previously put in place by this aircraft.

It is also possible to use the most suitable type of aircraft without comprising the installation.
said at least one air guidance line conveying an electrical current, said detection device is an induction-based detection device.

Alternatively, said guidance line being non-electrified, said or at least one of said detection devices comprises on its inner wall intended to be placed facing the air guidance line, sensors making it possible to locate the zone of contact between this air guidance line and the corresponding sensor.

Purely illustratively, the detection device comprising an annular link member, these sensors are regularly distributed over the perimeter of the internal wall of this link member.

Preferably, each sensor is capable of transmitting a contact signal when it is placed in contact with the air guidance line, this signal being sent to a processing unit of the aircraft to determine the zone of contact between the air guidance line and the detection device, and make a correction in the positioning of the aircraft relative to this guidance line on the basis of the signal or signals thus received.

They can be, for example, contact sensors.
this following means comprises two detection devices, each of these devices comprising an individually-controllable opening/closing mechanism to allow the switching of this aircraft from a first guidance line to another air guidance line without risk of loss thereof.
this system also comprising at least one light beam defining at least one section of air route, it comprises a second following means for following said at least one light beam, said second following means being configured to keep said aircraft aligned, or substantially aligned, on said at least one light beam.

The section of air route followed by the aircraft can thus be a combination of one or more air guidance lines and of one or more light beams.

As an example, this light beam is in the range of the infrared, visible or ultraviolet spectrum.

As an illustration, the second means for following said at least one light beam then comprises an image sensor chosen from the group comprising a visible image sensor, an infrared image sensor, an ultraviolet image sensor or even an image sensor sensitive in a spectral range from approximately 350 nm to 1000 nm.

This image sensor can, for example, be a video camera mounted on the drone by means of a 3-axis stabilization system.

Preferably, the guidance system comprises at least two light beams in the visible range, which exhibit different colors to define distinct section of air routes.

These section of air routes being at least partly parallel, this aircraft can switch from one air route to the other.

The second following means can comprise a computation unit for detecting the light beam or beams on the images taken by the image sensor and determining the position of the drone in relation to this or these markers defined by this or these light beams, in order to make it possible to follow this or one of these light beams. Optionally, when different markers are used to determine the position of the drone, and the computation unit comprises a set of data relating to the space in which the drone moves around, one or more objects visible on the ground can also be used as markers.

The second following means can also comprise a locking system for keeping a drone at a desired distance, and possibly an adjustable distance, from the light beam determining the section of air route to be followed. The motors of the aircraft are then individually controllable to pilot the drone in terms of altitude and speed.

Advantageously, said at least one light beam can be emitted by at least one laser source. The implementation of one or more laser beams makes it possible to easily and rapidly generate a section of an air route in an indoor or outdoor space. In fact, many compact and portable laser sources are known, which are suitable for defining a trajectory or optical path secured by the generation of a highly directional beam.

In order to generate such an optical path determining an section of air route, the guidance system can advantageously comprise one or more optical devices chosen from the group comprising a return mirror, a splitter plate, a light beam path switcher for guiding an incident laser beam to a selected one of a plurality of output ports for this laser beam, etc.

Thus, and purely illustratively, to form an section of air route that is inclined relative to a first section of air route, it is possible to use a return mirror the reflective front face of which is inclined relative to the first optical path of propagation of a light beam so as to return this beam with a particular inclination.

Advantageously, these optical devices make it possible to easily and rapidly generate an air trajectory even in complex environments, for example including obstacles.
this following means comprises an embedded image sensor capable of taking at least one image or a sequence of images of an observation zone, said guidance system also comprising a means for processing optical information contained in said image or images to detect at least one air guidance line or at least one light beam present in said observation zone.

The assembly formed by the embedded image sensor and the processing means can therefore be implemented to ensure the detection of at least one light beam or of at least one air guidance line in an observation zone, each light beam or each air guidance line defining an air route or a section of an air route. This assembly can also allow the detection of both, when this air route or this section of air route is defined by a combination of at least one air guidance line and of at least one light beam.

“Observation zone” is understood to mean a scene seen from the aircraft on which the image sensor is embedded. This scene can be placed laterally to the aircraft or in front, depending on the positioning of the embedded optical sensor. For example, with the optical sensor aiming in the main direction of the aircraft, images of a scene towards which the drone is directed are acquired by the image sensor.

The implementation of an optical sensor for detecting an air guidance line or a light beam requires a pre-positioning of the aircraft on the beam or line in order to ensure their initial marking.

This image sensor is, preferably, a digital camera such as a high definition camera.
said processing means being configured to determine the relative position of the aircraft in relation to said guidance line or said at least one light beam, said aircraft comprises a piloting system using the results obtained from the processing of said image or images by said processing means to ensure the alignment, or substantially the alignment, of said aircraft on said guidance line or said at least one light beam.

This image sensor can, alternatively or additionally, be capable of transmitting said at least one image or said sequence of images to a remote control device making it possible to remotely pilot this aircraft. This remote control device is linked to the aircraft by a radio link.

According to an embodiment of the invention, the guidance line can be formed by a cable lifeline. This lifeline comprises, for example, fixing points for fixing the lifeline to a structure such as a building. These fixing points are for example fixing anchors.

According to an embodiment of the invention, the guidance system comprises an arm configured to link the aircraft to the lifeline. Preferably, the free end of the arm comprises a link member configured to be attached to the lifeline while allowing it to slide along the lifeline. Advantageously, this link member is configured to allow the passage of the fixing points without detaching the link member. According to a particularly advantageous embodiment, this link member takes the form of a runner having a form suitable for allowing the automatic passage of the fixing points. In this way, the aircraft is held to the lifeline while being guided along the lifeline via the link member and the arm.

The present invention relates also to a method for managing at least two unmanned aircraft, for example a fleet of drones.

According to the invention, a distinct air route is associated with each drone, said drone being guided along said air route by a guidance system defined as described previously.

Such a method thus makes it possible to prevent collisions between unmanned aircraft placed in one and the same zone of space.

This particularly simple management method makes it possible to dispense with the implementation of complex devices for identifying each aircraft and for tracing relative movement between these uncrewed aircraft through a three-dimensional flying space.

### BRIEF DESCRIPTION OF THE DRAWINGS

Other advantages, aims and particular features of the present invention will emerge from the following description, given, in an explanatory and nonlimiting manner, in light of the attached drawings, in which:

FIG. 1 schematically shows a system for guiding an air drone along a section of an air route according to a first embodiment of the present invention;

FIG. 2 shows a view in transverse cross section of the detection device of the drone in the guidance system of FIG. 1;

FIG. 3 shows a system for guiding an aircraft according to a second embodiment of the present invention;

FIG. 4 shows a system for guiding an aircraft according to a third embodiment of the present invention.

### DETAILED DESCRIPTION OF EMBODIMENTS OF THE INVENTION

First of all, note that the figures are not to scale.

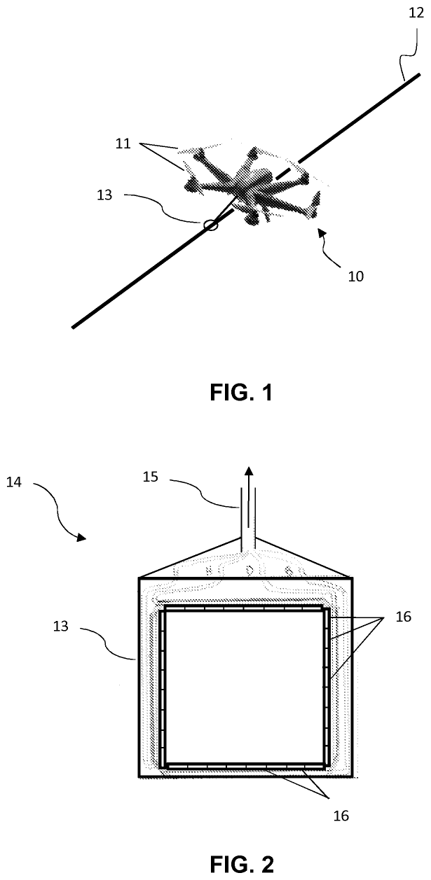

FIGS. 1 and 2 schematically represent a system for guiding an air drone 10 along a section of an air route according to a first embodiment of the present invention.

This drone 10 is, here, a rotary wing drone comprising several rotors 11 each driven by a dedicated motor (not represented), these motors being individually controllable to ensure the piloting of this drone 10 in terms of speed, altitude and in terms of its trim.

This drone 10 also comprises a set of sensors (not represented) such as an altimeter, one or more triaxial gyrometers and accelerometers.

It also comprises an embedded camera (not represented) for ensuring the taking of images, which are stored on an embedded storage unit, for example a memory card, and/or sent in the form of communication signals to a receiver on the ground.

This drone 10 also comprises an automatic piloting device (not represented) to allow this drone to maintain a trajectory defined by an air guidance line 12, which is, here, a physical guidance line such as a cable.

This automatic piloting device here comprises a digital computer receiving information from a plurality of sensors and determining, from this information, whether the drone is indeed on its trajectory or has drifted therefrom. This automatic piloting device is then suitable for acting on controls of the drone to correct any position deviation. The controls of the drone 10 are, here, the motors which are controlled in a differentiated manner.

The system for guiding the drone 10 also comprises a mechanical contact-based detection device 14 for detecting this guidance line 12 along which the in-flight movement of this drone is sought to be maintained.

In this embodiment, the mechanical detection device 15 comprises a closed ring 13 of substantially rectangular cross section, which is placed at the free end of a strut 15 borne by the drone 10. This strut 15 is preferably telescopic to adjust the distance separating the drone 10 from the air guidance line 12.

The closed ring 13 of the detection device 14 also comprises, on its inner wall intended to surround and be placed facing the air guidance line 12, a plurality of pressure-sensitive sensors 16. These sensors 16 make it possible to locate the zone of contact between the guidance line 12 and the inner wall of the closed ring 13. These sensors are preferably distributed uniformly on the surface of this inner wall to ensure that the mechanical detection device 14 has good sensitivity.

When contact is established between such a sensor 16 and the guidance line 12, the sensor 16 emits an electrical signal which is sent to the digital computer of the drone. From this or these contact signal (signals), the digital computer identifies a change of trajectory of the drone 10 and a correction to be made thereto in order to keep the movement of this drone 10 along the guidance line 12 defining an air route. Obviously, the drone 10 is free to explore the zone of space delimited by its detection device 14 around the air guidance line 12.

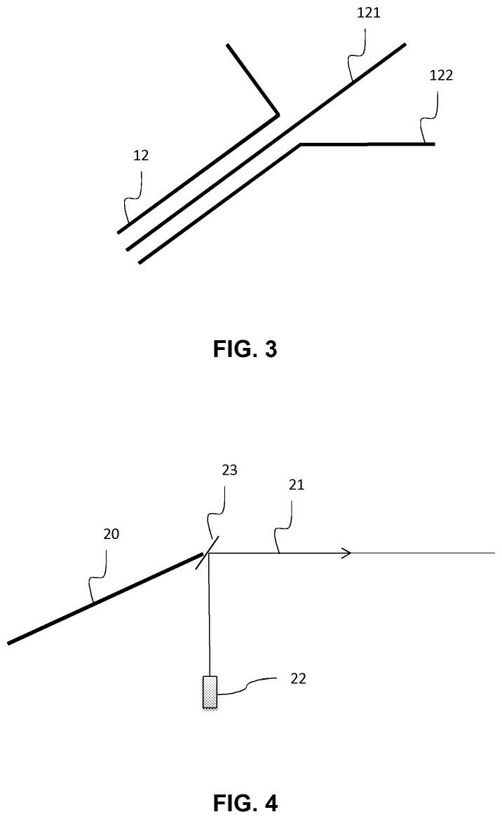

FIG. 3 shows a system for guiding an aircraft according to a second embodiment of the present invention.

This guidance system comprises a plurality of air guidance lines 12, 121, 122 placed side-by-side and parallel, or substantially parallel, over a part of their longitudinal dimension.

These guidance lines 12, 121, 122 which determine distinct air routes, are separated from one another at one of their ends to define different directions that an aircraft (not represented) can take by following one of these guidance lines 12, 121, 122.

Each of these guidance lines 12, 121, 122 is, here, formed by a physical guidance line, such as a rod made of plastic material obtained for example by molding. Obviously, support means, not represented in the interests of clarity, make it possible to support this air guidance line at a predetermined height, and possibly adjustable height, relative to the ground. In particular, this height can be predefined to ensure the safety of people located in the action zone of the drone 10. These support means can, for example, support the ends of this physical guidance line.

This aircraft comprises a following means for keeping the movement thereof along one of the air guidance lines 12, 121, 122. This mechanical following means here comprises two mechanical detection devices, which are borne by the aircraft, under its fuselage, by being aligned along the longitudinal axis thereof.

Each mechanical detection device comprises a strut, at the free end of which is placed an annular link member, as well as a mechanism for opening/closing this annular link member to open and close the member.

The aircraft also comprises an embedded computation unit linked to each mechanical detection device to individually control each opening/closing mechanism.

Thus, when the aircraft is guided by a first air guidance line 12 defining a first section of the air route that it has to take and a change of trajectory of this aircraft is necessary to follow a new section of air route, distinct from the first, the following steps are performed in succession:
the aircraft is first of all immobilized in stationary flight,
the computation unit of this aircraft controls the opening of the annular link member of a first mechanical detection device, by sending a control signal to the corresponding opening/closing mechanism, the annular link member of the other, or second, mechanical detection device being closed around the first air guidance line 12,
the aircraft maneuvers to free the annular link member of the first mechanical detection device from this first air guidance line 12 to place the latter on the new air guidance line 121 to be followed,
the annular link member of the first mechanical detection device at least partly surrounding this new air guidance line 121, the computation unit sends a control signal to the opening/closing mechanism of this first mechanical detection device to close its annular link member around this new guidance line 121 and thus secure the aircraft thereto,
the computation unit then sends a control signal to the opening/closing mechanism of the annular link member of the second mechanical detection device of the aircraft still linked to the first air guidance line 12 in order to open its link member and thus completely free the aircraft from the first air guidance line 12,
the aircraft then maneuvers to place this link member of the second mechanical detection device facing the new air guidance line 121,
the computation unit then sends a control signal to the opening/closing mechanism of this second mechanical detection device to close its link member around the new air guidance line 121,
the aircraft being linked to this new air guidance line 121 by its two mechanical detection devices, it can then resume its flight by being guided by this new air guidance line 121.

According to another embodiment of the invention, these three sections 12, 121, 122 of an air route are formed by a set of three partly-parallel light beams, these light beams having distinct colors, each light beam being emitted by a different light source such as a laser source.

The switch from a first section 12 of air route defined by a light beam of a first color to a second air route 121 defined by a light beam of a second color, distinct from the first color, is then easier and more rapid. It is in fact sufficient, after identification of each light beam and of the color which is associated with it, for the computation unit to control the trajectory of the aircraft in order for it to move along the light beam the color of which defines the new section of air route to be followed. Nevertheless, the aircraft is not then secured against falling.

FIG. 4 shows a system for guiding an aircraft according to a third embodiment of the present invention.

The air route along which the aircraft is guided is formed by a first section of air route defined by an air guidance line 20 and a second section of air route defined by a visible light beam 21 emitted by a light source 22 such as a laser source. The trajectory of the visible light beam 21 can be defined by one or more optical elements 23 which orient this light beam 21 in a determined direction.

This air route is therefore a combination of a physical line 20 here composed of a cord, for example, and a laser beam 21 emitted in the visible range, for example of blue color.

The following means of the aircraft comprise, on the one hand, a mechanical contact-based detection device making it possible to follow this air guidance line 20, which is, for example, placed under the fuselage of the aircraft and, on the other hand, an embedded image sensor capable of taking a sequence of images of an observation zone to allow the detection and the identification of a light beam 21.

The following means also comprises a computation unit making it possible to individually control the mechanical detection device and the image sensor and to switch from one to the other depending on the nature—physical line 20 or light beam 21—of the section of air route followed at a given instant.

The computation unit advantageously comprises a processor and software instructions which, when they are executed by this processor, make it possible to perform the steps of an image processing method to identify the light beam 21 on the images taken by the image sensor.

The light beam 21 thus identified defining a spatial marker for the aircraft, the computation unit is capable of determining in real time the relative position of the aircraft relative to this marker.

An automatic piloting system of the aircraft using the results obtained from the processing of the images by the computation unit maintains the alignment or substantially the alignment of this aircraft on the light beam 21.

Obviously, the following means of the aircraft could be limited to just the assembly comprising the image sensor and the computation unit, the aircraft then being guided along the section of air route by detection, on the acquired images, of the air guidance line 20 or of the light beam 21, and locking of the controls of the aircraft onto the distance separating the aircraft from the beam 21 or this line 20 thus detected.

1. A guidance system for guiding an aircraft (10) along at least one section of an air route, comprising:
at least one air guidance line (12) defining at least one section of air route,
a means for following said at least one guidance line (12), borne by said aircraft (10), said following means being configured to keep said aircraft (10) aligned, or substantially aligned, on said at least one air guidance line (12), wherein
said following means comprises an arm (15) configured to link the aircraft (10) to said at least one guidance line (12).

2. The system as claimed in claim 1, wherein said arm (15) is a telescopic arm.

3. The system as claimed in claim 1, wherein each air guidance line (12) is chosen from the group comprising a cable, a wire, a cord, a solid or hollow bar, and combinations of these elements.

4. The system as claimed in claim 1, wherein said following means comprises at least one contact-based mechanical detection device (14) or one induction-based device for detecting said at least one guidance line (12) to follow said line.

5. The system as claimed in claim 4, wherein each detection device comprises a link member placed at the free end of said arm (15), said link member being chosen from the group comprising an open or closed ring (13), an openable ring, a tubular portion, longitudinally open or not, an openable tubular portion and combinations of these elements.

6. The system as claimed in claim 4, wherein, said air guidance line (12) conveying an electrical current, said detection device is an induction-based detection device.

7. The system as claimed in claim 4, wherein said or at least one of said detection devices comprises, on its inner wall intended to be placed facing said corresponding air guidance line (12), sensors (16) making it possible to locate the zone of contact between said guidance line (12) and the corresponding detection device.

8. The system as claimed in claim 4, wherein, said following means comprising two detection devices, each of those detection devices comprising an individually-controllable opening/closing mechanism to allow the switching of said aircraft (10) from a first guidance line (12) to another air guidance line (12) without risk of loss of the aircraft (10).

9. The system as claimed in claim 1, wherein, said system also comprising at least one light beam defining at least one section of air route, it comprises a second following means for following said at least one light beam, said second following means being configured to keep said aircraft (10) aligned, or substantially aligned, on said at least one light beam.

10. The system as claimed in claim 1, wherein said following means comprises an embedded image sensor capable of taking at least one image or a sequence of images of an observation zone, said guidance system also comprising a means for processing optical information contained in said image or images to detect at least one air guidance line (12) present in said observation zone.

11. The system as claimed in claim 10, wherein, said processing means being configured to determine the relative position of the aircraft (10) relative to said guidance line (12), said aircraft (10) comprises a piloting system using the results obtained from the processing of said image or images by said processing means to ensure the alignment, or substantially the alignment, of said aircraft (10) on said guidance line (12).

12. The system as claimed in claim 10, wherein said image sensor is capable of transmitting said at least one image or said sequence of images to a remote control device making it possible to remotely pilot said aircraft (10).

13. A method for managing a fleet of drones, wherein a distinct air route is associated with each drone, said drone being guided along said air route by a guidance system defined as claimed in claim 1.

14. The system as claimed in claim 2, wherein each air guidance line (12) is chosen from the group comprising a cable, a wire, a cord, a solid or hollow bar, and combinations of these elements.

15. The system as claimed in claim 2, wherein said following means comprises at least one contact-based mechanical detection device (14) or one induction-based device for detecting said at least one guidance line (12) to follow said line.

16. The system as claimed in claim 3, wherein said following means comprises at least one contact-based mechanical detection device (14) or one induction-based device for detecting said at least one guidance line (12) to follow said line.

17. The system as claimed in claim 5, wherein, said air guidance line (12) conveying an electrical current, said detection device is an induction-based detection device.

18. The system as claimed in claim 5, wherein said or at least one of said detection devices comprises, on its inner wall intended to be placed facing said corresponding air guidance line (12), sensors (16) making it possible to locate the zone of contact between said guidance line (12) and the corresponding detection device.

19. The system as claimed in claim 5, wherein, said following means comprising two detection devices, each of those detection devices comprising an individually-controllable opening/closing mechanism to allow the switching of said aircraft (10) from a first guidance line (12) to another air guidance line (12) without risk of loss of the aircraft (10).

20. The system as claimed in claim 6, wherein, said following means comprising two detection devices, each of those detection devices comprising an individually-controllable opening/closing mechanism to allow the switching of said aircraft (10) from a first guidance line (12) to another air guidance line (12) without risk of loss of the aircraft (10).
